(19) United States
(12) Patent Application Publication
(10) Pub. No.: US 2026/0090952 A1
(43) Pub. Date: Apr. 2, 2026

(54) MASSAGE APPARATUS

(71) Applicant: Alan Tam, Quarry Bay (HK)

(72) Inventor: Alan Tam, Quarry Bay (HK)

(73) Assignee: Reestar International Limited, Kowloon (HK)

(21) Appl. No.: 18/831,222

(22) Filed: Sep. 27, 2024

(51) Int. Cl. A61H 23/00; A61H 23/02; A61H 23/04

(52) U.S. Cl. CPC A61H 23/006; A61H 23/0254; A61H 23/04; A61H 2201/1215; A61H 2201/1246; A61H 2201/1436; A61H 2201/1664; A61H 2201/50; A61H 2201/5061; A61H 2201/5064

(57) ABSTRACT

A massage apparatus for massaging on a user's body by a massage head moving at least linearly in a longitudinal direction of the massage head, configured so that a massaging element moves toward the massage head by way of air pressure fluctuation in an air chamber when a driving element is moved from a first position to a second position. In addition, the stroke center position of the reciprocating movement of the driving element moved between the first position and the second position is configured to be changeable.

### FIELD OF THE INVENTION

The invention relates to the field of massage equipment, in particular to a massage apparatus.

### BACKGROUND OF THE INVENTION

For the massage apparatus of the present invention, when a massaging operation while pushing a tip of the massage head against a user's body, a stroke amount of the driving element is varied in accordance with pushing force that a user applies to the massage apparatus. Thereby, the massage apparatus controls impact force during the massaging operation.

### BRIEF SUMMARY OF THE INVENTION

In the massage apparatus which drives the massaging element via the air spring effect, it was found that a return speed of the massaging element or a return amount of the massaging element is not always constant due to differences of massaging operation aspects, for example massaging different locations of a user's body. As the hardness of a user's body is harder, massaging reaction force applied on the massaging element becomes larger, as the hardness of a user's body is softer, massaging reaction force becomes smaller, and further the return speed of the massaging element and the return amount of the massaging element are varied by the massaging reaction force. As described above, when the return speed or the return amount of the massaging element varies, a distance between the massaging element and the driving element varies, and impact energy transmitted from the massaging element to the massage head varies. The object of the present invention is to provide an improved massage apparatus which is capable of performing a rational massaging operation.

According to a preferable aspect of a massage apparatus according to the present invention, the massage apparatus which drives a massage head at least linearly in a longitudinal direction of the massage head and performs a massaging operation on a user's body is constructed. The massage apparatus comprises a main housing, a cylinder which is arranged in the main housing and extended in the longitudinal direction of the massage head, a massaging element which drives linearly in the longitudinal direction of the massage head in the cylinder and interchangeably connects the massage head, a driving element which is slidably arranged in the cylinder and is configured to moves the massaging element, and a driving apparatus which drives the driving element. The driving element is arranged inside the cylinder such that it is reciprocally movable between a first position which is remote from the massage head and a second position which is close to the massage head. When the driving element is moved from the first position to the second position, the driving element moves the massaging element via an air spring effect toward the massage head and the massaging element interchangeably connects the massage head. Further, a stroke center position of a reciprocating movement of the driving element which is reciprocally moved between the first position and the second position is configured to be changeable.

Further, a stroke length is a distance between the first position and the second position. The stroke center position is positioned at the same distance from the first position and the second position between the first position and the second position. Further, the first position and the second position are moved due to a movement of the stroke center position. The stroke center position may be changed by moving a part of a driving apparatus for driving the driving element.

According to the present invention, since the stroke center position of the reciprocating movement of the driving element which is moved between the first position and the second position is changeable, a massage apparatus which is capable of performing a rationalized massage operation according to an operation aspect is provided. For example, in the massage apparatus which is constructed to drive the massaging element via an air spring effect of an air chamber, the characteristic of the air spring effect is varied by changing the distance between the driving element and the massaging element based on the hardness of a user's body. Specifically, if a user's body is harder, the stroke center position of the driving element is moved to be remote from the massage head, and if a user's body is softer, the stroke center position of the driving element is moved to be close to the massage head. Thereby, by controlling the characteristic of the air spring effect, variation in impact energy based on the hardness of a user's body is suppressed. As a result, the massaging operation is appropriately performed.

Further, for example, when the massaging operation is started, in order to move actively the resting massaging element, the stroke center position of the driving element is moved to be close to the massage head. On the other hand, after starting the massaging operation, the stroke center position of the driving element may be moved to be remote from the massage head.

According to a further aspect of the massage apparatus according to the present invention, the massage apparatus comprises a switch apparatus for changing the stroke center position. Further, change of the stroke center position by the switch apparatus may be performed in a stepping manner or in a step less manner.

According to this aspect, the stroke center position of the reciprocating movement of the driving element is changed by the switch apparatus.

According to a further aspect of the massage apparatus according to the present invention, the switch apparatus is configured to be operable by a user.

According to this aspect, as the switch apparatus is operable by a user, a user can change the stroke center position of the reciprocating movement of the driving element according to an operation aspect.

According to a further aspect of the massage apparatus according to the present invention, the massage apparatus comprises a control panel which controls the switch apparatus. Further, the control panel is configured to change the stroke center position by controlling the switch apparatus.

According to this aspect, as the control panel controls the switch apparatus and thereby changes the stroke center position, the stroke center position is automatically changed.

According to a further aspect of the massage apparatus according to the present invention, the massage apparatus comprises a first sensor which measures reaction force caused by the massaging operation of the massage head. Further, the control panel is configured to control the switch apparatus based on a measured result of the first sensor and change the stroke center position.

According to this aspect, the control panel controls the switch apparatus based on the reaction force caused by the massaging operation of the massage head. Accordingly, the stroke center position of the reciprocating movement of the driving element is automatically changed based on a reaction force level of the reaction force.

According to a further aspect of the massage apparatus according to the present invention, the massage apparatus comprises a second sensor which measures a position of the massage head. Further, the control panel is configured to control the switch apparatus based on a measured result of the second sensor and change the stroke center position. Further, the second sensor may directly detect the position of the massage head or detect the position of the massage head by detecting the position of the massaging element.

According to this aspect, the control panel controls the switch apparatus based on the position of the massage head. Accordingly, the stroke center position of the reciprocating movement of the driving element is automatically changed based on the position of the massage head.

According to a further aspect of the massage apparatus according to the present invention, the massage apparatus comprises a third sensor which measures vibration caused on the main housing. Further, the control panel is configured to control the switch apparatus based on a measured result of the third sensor and change the stroke center position.

According to this aspect, the control panel controls the switch apparatus based on a vibration level of the vibration caused on the main housing. Accordingly, the stroke center position of the reciprocating movement of the driving element is automatically changed based on the vibration caused on the main housing.

According to a further aspect of the massage apparatus according to the present invention, the massage apparatus comprises a fourth sensor which measures a parameter applied on the driving apparatus, the parameter indicating a load state of the massage head. Further the control panel is configured to control the switch apparatus based on a measured result of the fourth sensor and change′ the stroke center position.

Further, the parameter indicates the load state of the massage apparatus (100) corresponds to, for example, current of a motor or a heat generation of the motor.

According to this aspect, the control panel controls the switch apparatus based on the load state of the massage apparatus. Accordingly, the stroke center position of the reciprocating movement of the driving element is automatically changed based on the load state of the massage apparatus.

According to a further aspect of the massage apparatus according to the present invention, the driving apparatus comprises a motor electrically connected to a battery and a crank mechanism which is rotationally driven by the motor. The crank mechanism comprises an eccentric flywheel which has an eccentric pin, the eccentric flywheel rotationally driven by the motor, and a swing member which is connected to the eccentric pin swingably around the eccentric pin. The massage apparatus further comprises a connection rod which connects the swing member and the driving element, one end side of the connection rod is swingably connected to the swing member and the other end side is swingably connected to the driving element, and a control member one end side of which having a control slot is swingably connected to the swing member and the other end side of which is swingably connected to a switching member arranged on the main housing. Further, the stroke center position is changed by changing a position of the switching member. Further, the position of the switching member may be configured to be changeable by a user.

According to a further aspect of the massage apparatus according to the present invention, a stroke length of the driving element is change when the stroke center position is changed.

According to this aspect, the stroke length of the driving element is changed due to a position change of the driving element. In such a case, it is preferable that when the stroke center position is moved to be close to the massage head, the stroke length becomes shorter, and when the stroke center position is moved to be remote from the massage head, the stroke length becomes longer. Thus, the massage apparatus is appropriately driven according to operation aspects.

According to a further aspect of the massage apparatus according to the present invention, the massage apparatus comprises a connection rod which is connected to the driving element, and a crank mechanism which is connected to the connection rod and drives the driving element. While the driving element is moved from a bottom dead center which is the most remote from the massage head to a top dead center which is the closest to the massage head, a straight line passing a connecting part of the connection rod and the driving element and a connecting part of the connection rod and the crank mechanism is arranged to be parallel to the cylinder. Further, the driving element typically corresponds to a driving element which slides within the cylinder.

At the bottom dead center which corresponds to 0 degrees crank angle and the top dead center which corresponds to 180 degrees crank angle, the velocity of the driving element in a moving direction of the driving element becomes equal to zero. That is, to drive the massaging element toward the massage head while the driving element is moved from the bottom dead center to the top dead center is reasonable. For example, in an air driving type massage apparatus, as the massaging element is slidable, air inside the cylinder maximally compressed while the driving element is moved from the bottom dead center to the top dead center is preferable. According to the aspect, while the driving element is moved from the bottom dead center to the top dead center, the connection rod is arranged to be parallel to the cylinder. Accordingly, in a maximally compressed status, force in a direction crossing the moving direction of the driving element is prevented from applying on the driving element. Thus, friction loss between the driving element and the cylinder is reduced. As a result, the driving element is efficiently driven.

According to a further aspect of the massage apparatus according to the present invention, with respect to a crank angle of the crank mechanism, the bottom dead center corresponds to 0 degree crank angle and the top dead center corresponds to 180 degrees crank angle. Further, when the driving element is located at substantially 90 degrees crank angle position during a rotation from the bottom dead center to the top dead center, the connection rod becomes parallel to the cylinder.

In the massage apparatus in which the driving element is driven by the crank mechanism, velocity of the driving element toward the massage head becomes maximum speed in substantially 90 degrees crank angle position of the crank mechanism. For example, in the massage apparatus in which the massage head is hit by utilizing an air spring, when the driving element is located at substantially 90 degrees angle position on the way to the top dead center from the bottom dead center, an air chamber which serves the air spring is defined to be maximally compressed. Accordingly, it is preferable that at the substantially 90 degrees crank angle position, the connection rod becomes parallel to the cylinder. Further, in this aspect, the substantially 90 degrees means a range between 70 degrees through 110 degrees.

Further, according to a further aspect of the massage apparatus according to the present invention, when the connection rod is parallel to the cylinder, the massaging element is configured to start to move toward the massage head. According to his aspect, force applied on the driving element in a direction crossing the moving direction of the driving element is reduced. Thus, friction loss between the driving element and the cylinder is reduced. As a result, kinetic energy of the driving element is efficiently transmitted to the massaging element.

Further, according to a further aspect of the massage apparatus according to the present invention, a rotation center of the crank mechanism is arranged to be offset from a reciprocating moving line of the driving element moved inside the cylinder with respect to a direction crossing the reciprocating moving line.

According to this aspect, the rotation center of the crank mechanism is offset from the reciprocating moving line of the driving element in the direction crossing the reciprocating moving line. Accordingly, by adjusting an offset amount, the connection rod is easily set to be parallel to the cylinder while the driving element is moved from the bottom dead center to the top dead center.

Further, according to a further aspect of the massage apparatus according to the present invention, the crank mechanism comprises a rotatable eccentric flywheel and an eccentric pin connected to the eccentric flywheel at a position eccentric from a rotational axis of the eccentric flywheel. Further, the massage apparatus further comprises a swing member which is interveningly arranged between the eccentric pin and the connection rod and swingably connected to both. of the eccentric pin and the connection rod respectively, and a switching member one end side of which is swingably supported on the main housing and the other end side of which is swingably connected to the swing member.

According to this aspect, as the swing member is arranged between the eccentric pin and the connection rod, when the eccentric pin is rotated, a connecting part of the swing member which is connected to the connection rod performs an orbital motion along substantially ellipse track. The longitudinal axis of the ellipse extends along the moving direction of the driving element. Thus, a moving amount of the connecting part in the moving direction of the driving element is larger than a moving amount of the eccentric pin in the moving direction of the driving element. That is, with respect to the moving direction of the driving element, the moving amount of the eccentric pin is amplified and transmitted to the driving element. Therefore, a moving amount of the eccentric pin in a direction crossing the moving direction of the driving element is much smaller than the moving amount of the driving element. Accordingly, swing angle of the connection rod becomes smaller and thereby interference of the connection rod against the cylinder is prevented. Further, axial length of the connection rod may be shortened. As a result, the driving apparatus is able to be arranged close to the cylinder. Thus, downsizing of the massage apparatus is achieved.

Further, according to a further aspect of the massage apparatus according to the present invention, the massage apparatus comprises a connection pin which connects the swing member and the connection rod in a swingable manner to each other, and a control pin which connects the swing member and the control member in a swingable manner to each other. Further, the eccentric pin is arranged between the connection pin and the control pin in an extending direction of a line passing the connection pin and the control pin.

According to this aspect, each component of the crank mechanism is rationally arranged.

Accordingly, an improved massage apparatus which is capable of performing a rational massaging operation is provided.

Other objects, features and advantages of the present invention will be readily understood after reading the following detailed description together with the accompany drawings and the claims.

### BRIEF DESCRIPTION OF THE SEVERAL VIEWS OF THE DRAWINGS

FIG. 1 is a fragmentary cross-sectional view of whole construction of a massage apparatus.

FIG. 2 shows a view for comparing between driving element positions at a bottom dead center of the driving element in which a state that a stroke center position is moved rearward (remote side from a massage head) is illustrated by straight lines, and a state that the stroke center position is moved forward (close side to the massage head) is illustrated by broken lines.

FIG. 3 shows a view for comparing between driving element positions at a top dead center of the driving element in which a state that a stroke center position is moved forward is illustrated by straight lines, and a state that the stroke center position is moved rearward is illustrated by broken lines.

FIG. 4 is a fragmentary cross-sectional view of operating link type crank mechanism in which the stroke center position of the driving element is moved rearward and dhows the bottom dead center in which the driving element is moved to the most rear position (0 degree crank angle position).

FIG. 5 is a fragmentary cross-sectional view in which the driving element is moved (to substantially 90 degrees crank angle position) from the bottom dead center shown in FIG. 4 toward the top dead center and shows air chamber maximally compressed state.

FIG. 6 is a fragmentary cross-sectional view of the top dead center in which the driving element is moved to the most front position (180 degrees crank angle position).

FIG. 7 is a fragmentary cross-sectional view in which the driving element is moved (to substantially 270 degrees crank angle position) from the top dead center toward the bottom dead center.

FIG. 8 is a fragmentary cross-sectional view of operating link type crank mechanism in which the stroke center position of the driving element is moved frontward and shows the bottom dead center in which the driving element is moved to the most rear position (0 degree crank angle position).

FIG. 9 is a fragmentary cross-sectional view in which the driving element is moved (to substantially 90 degrees crank angle position) from the bottom dead center shown in FIG. 8 toward the top dead center and shows air chamber maximally compressed state.

FIG. 10 is a fragmentary cross-sectional view of the top dead center in which the driving element is moved to the most front position (180 degrees crank angle position).

FIG. 11 is a fragmentary cross-sectional view in which the driving element is moved (to substantially 270 degrees crank angle position) from the top dead center toward the bottom dead center.

FIG. 12 is a fragmentary cross-sectional view taken along lines 12-12 in FIG. 6.

FIG. 13 is a fragmentary cross-sectional view taken along lines 13-13 in FIG. 6.

### DESCRIPTION OF THE PREFERRED EMBODIMENTS

Each of the additional features and method steps disclosed above and below may be utilized separately or in conjunction with other features and method steps to provide and manufacture improved massage apparatus and method for using such massage apparatus and devices utilized therein. Representative examples of the invention, which examples utilized many of these additional features and method steps in conjunction, will now be described in detail with reference to the drawings. This detail description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

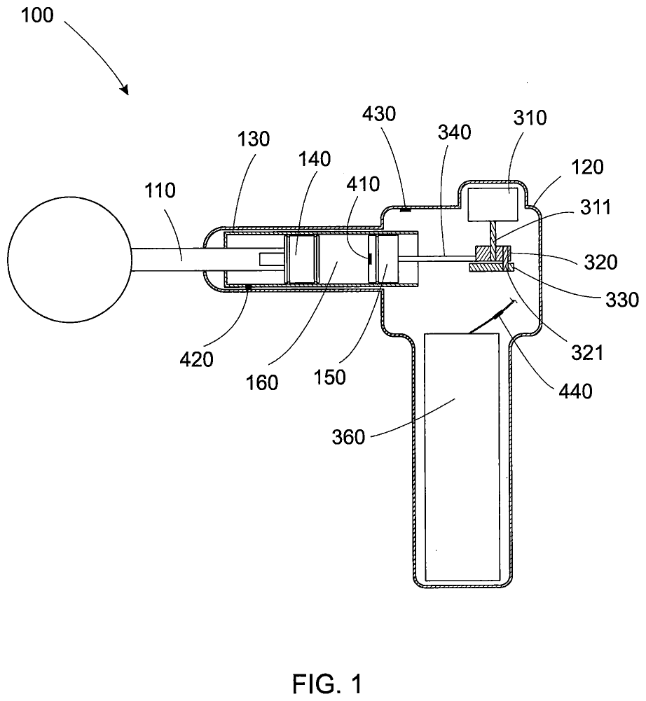

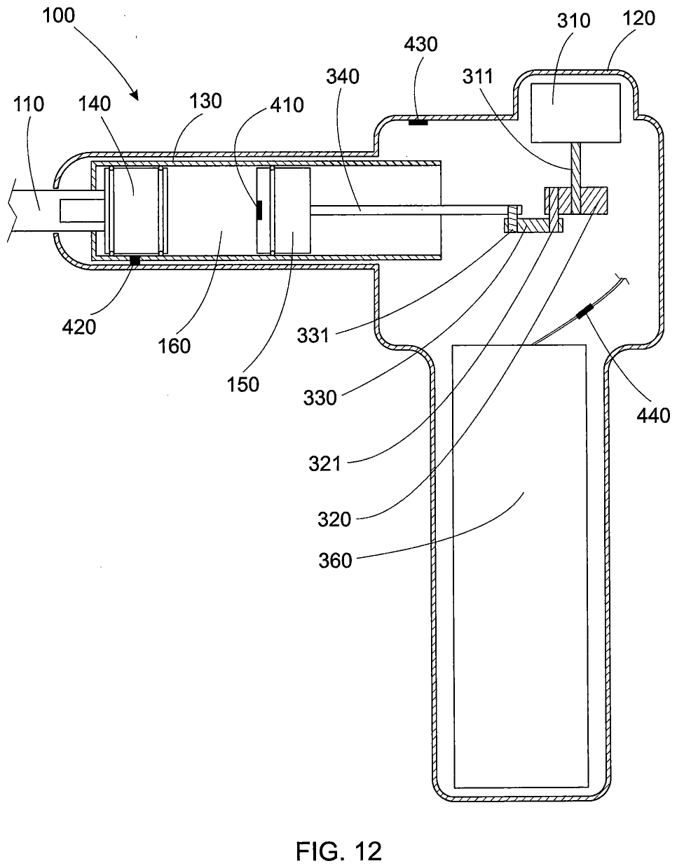

With reference to FIG. 1 to FIG. 13, an electric massage apparatus as one example of the massage apparatus is used for explanation. As shown in FIG. 1, a massage apparatus 100 is a massage apparatus to which a massage head 110 is attached and drives the attached massage head 110 linearly in a longitudinal direction and around the longitudinal direction of the massage head 110 and thereby performs a massaging operation on a user's body.

As shown in FIG. 1, the massage apparatus 100 is mainly provided with a main housing 120 which forms an outline of the massage apparatus 100.

For convenience of explanation, the massage head 110 side of the main housing 120 in a longitudinal direction of the main housing 120 is defined as a front side or a forward side, the opposite side along the longitudinal direction of the main housing 120 is defined as a rear side or a rearward side.

As shown in FIG. 1, the main housing 120 houses an electric motor 310, The electric motor 310 is arranged such that a motor shaft 311 is inconformity with a vertical direction which is substantially perpendicular to the longitudinal direction of the main housing 120 (longitudinal direction of the massage head 110). Torque of the electric motor 310 is converted as needed into a linear motion by the crank mechanism and thereafter transmitted to the massaging element 140, and causes impact force in the longitudinal direction of the massage head 110 (lateral direction of FIG. 1) via the massaging element 140. The electric motor 310 is an example of a feature which corresponds to “a motor (310)” of the present invention.

As shown in FIG. 1, the driving element 150 is provided as a driving member which drives the massaging element 140. The driving element 150 is linearly reciprocated within a cylinder 130 in a direction same as the longitudinal direction of the massage head 110. The cylinder 130 is provided as a cylindrical member and supported in a fixed manner against the main housing 120. The driving element 150 is an example of a feature which corresponds to “a driving element (150)” of the present invention.

As shown in FIG. 1, an inner wall of the cylinder 130, the driving element 150 and massaging element 140 form an air chamber 160.

Next, the link type crank mechanism for linearly reciprocating the driving element 150 is explained with reference to FIG. 1 to FIG. 3. The link type crank mechanism is mainly provided with an eccentric flywheel 320, a swing member 330 and a control member 350, and the link type crank mechanism is arranged rearward of the cylinder 130 (rearward of the driving element 150). The link type crank mechanism and the driving element 150 are connected by the connection rod 340. The link type crank mechanism is an example of a feature which corresponds to “a driving apparatus” of the present invention. Further, the eccentric flywheel 320 is an example of a feature which corresponds to “an eccentric flywheel”, and the swing member 330 is an example of a feature which corresponds to “a swing member”, and the control member 350 is an example of a feature which corresponds to “a control member” of the present invention.

One end of the connection rod 340 in its axial direction is connected in a relatively rotatable manner to the driving element 150 via a driving pin 341. The eccentric pin 321 is an example of a feature which corresponds to “an eccentric pin (321)” of the present invention.

The swing member 330 is arranged so as to extend perpendicular to a longitudinal direction of the driving element 150. Further, an intermediate region in the extending direction of the swing member 330 is connected in a relative rotatable (swingable) manner to the eccentric pin 321 of the eccentric flywheel 320. Further, one end of the swing member 330 in its extending direction in rotatably connected to the other end of the connection rod 340 in its axial direction via the connection pin 331.

The control member 350 having a control slot 351 is arranged so as to extend in the front-rear direction. One end of the control member 350 is connected in a relatively rotatable manner to other end of the swing member 330 in its extending direction via a control pin 332 in the control slot 351. Further, the other end of the control member 350 is connected in a swingable manner to the main housing 120. Accordingly, the control member 350 swings and thereby controls movement of the swing member 330. In other words, the control member 350 is provided as a regulation member which regulates the degree of the freedom of movement of the swing member 330 such that the link type crank mechanism performs a predetermined operation.

In the massage apparatus 100 constructed above, when the electric motor 310 is tuned on and driven, the driving element 150 is linearly moved within the cylinder 130 via the link type crank mechanism. Accordingly, air pressure in the air chamber 160 is fluctuated, and thereby the massaging element 140 interchangeably connecting the massage head 110 is moved forward by the air spring effect.

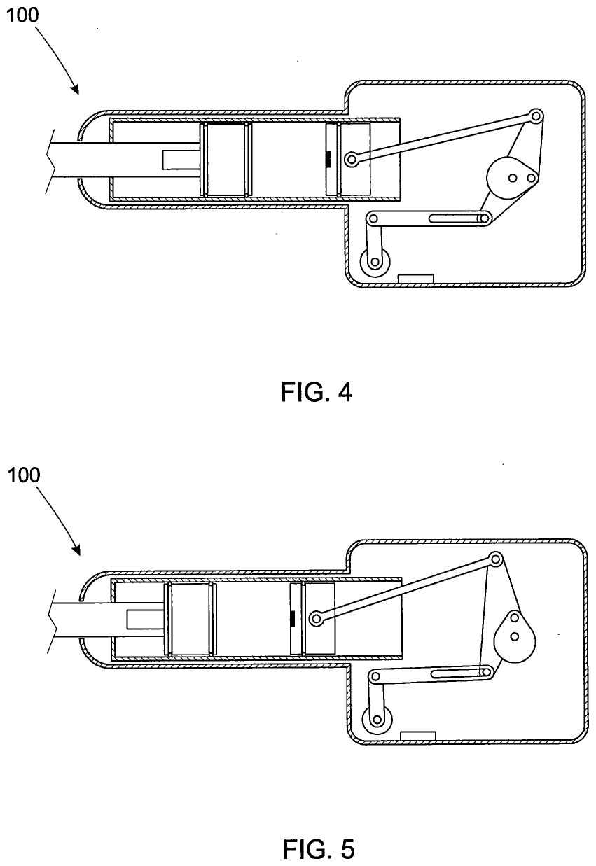

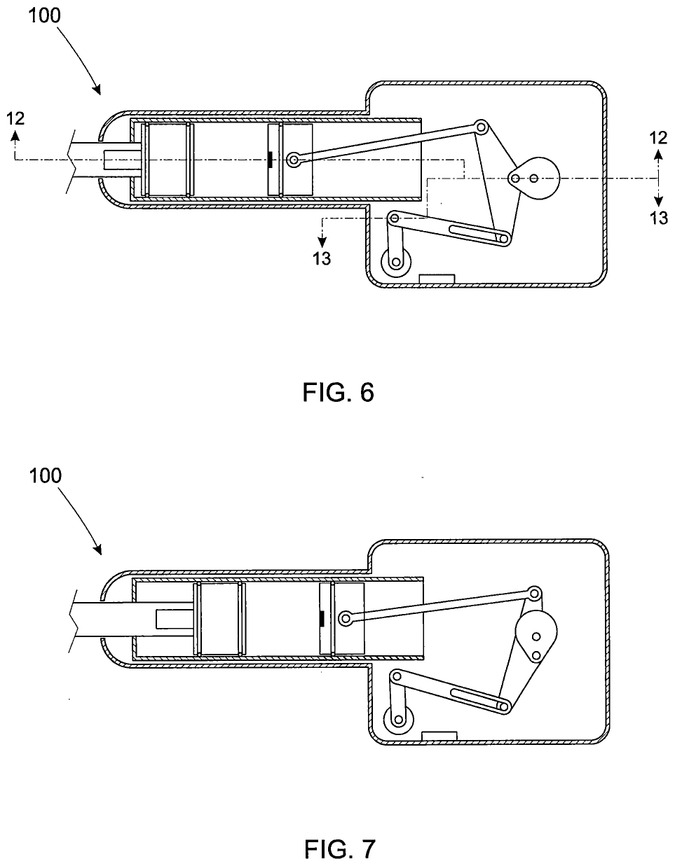

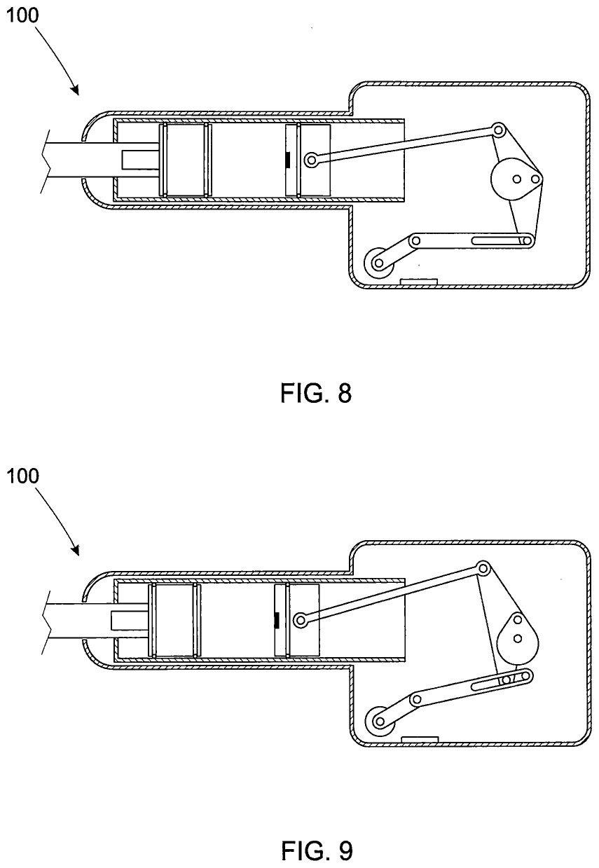

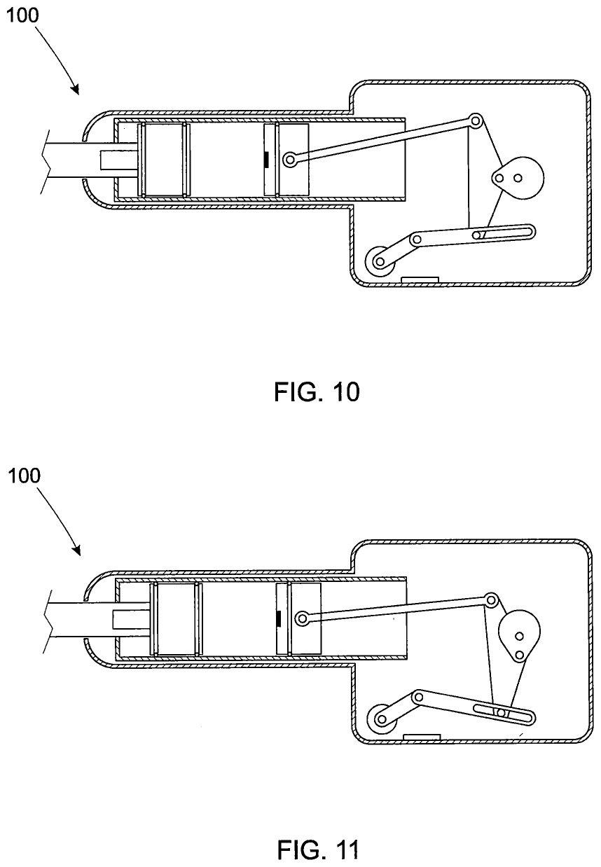

FIG. 4 to FIG. 11 illustrate movement of the driving element 150, that is, FIG. 4 and FIG. 8 illustrate a status of the driving element 150 in which it is moved and positioned in the most rear position (hereinafter called as bottom dead center) which is 0 degree (360 degrees) crank angle position with respect to position of the eccentric pin 321. FIG. 6 and FIG. 10 illustrate a status of the driving element 150 in which it is moved and positioned in the most front position (hereinafter called as top dead center) which is 180 degrees crank angle position with respect to position of the eccentric pin 321. The bottom dead center is an example of a feature which corresponds to “a first position”, and the top dead center is an example of a feature which corresponds to “a second position” of the present invention.

The driving element 150 is reciprocated between the top dead center and the bottom dead center. When, the driving element 150 is moved forward from the bottom dead center to the top dead center, the massaging element 140 interchangeably connecting the massage head 110 is moved forward via the air spring effect of the air chamber 160. As shown in FIG. 7 and FIG. 11, after massaging operation, the massaging element 140 is returned rearward by the massaging reaction force and negative pressure which is caused by declaration in air pressure of the air chamber 160 when the driving element 150 is moved from the top dead center to the bottom top center.

In the massage apparatus 100 which drives the massaging element 140 via the air spring effect of the air chamber 160, maximum air compression state of the air chamber 160 is defined by positions of the driving element 150 and the massaging element 140. As shown in FIG. 5 and FIG. 9, after the massaging operation, the massaging element 140 is moved rearward by the massaging reaction and the negative pressure to be close to the driving element 150 which is moved forward for the next massaging operation, and thereby the air chamber 160 becomes the maximum air compression state. The position of the driving element 150 corresponding to the maximum air compression state is generally defined as substantially 90 degrees (within the range between 70 to 110 degrees) crank angle position proceeded from the bottom dead center toward the top dead center.

The inventor found that the massaging reaction force applied to the massaging element 140 is changed based on a kind of a user's body, especially hardness of the user's body. Further, a return speed or a return amount of the massaging element 140 is changed by such a fluctuation of the reaction force. As a result, distance between the driving element 150 and the massaging element 140 is changed. That is, when user's body is hard, distance between the driving element 150 and the massaging element 140 becomes short, and when user's body is soft, distance between the driving element 150 and the massaging element 140 becomes long. Accordingly, the inventor found that impact energy transmitted to the massage head 110 is changed based on change of the distance between the driving element 150 and the massaging element 140.

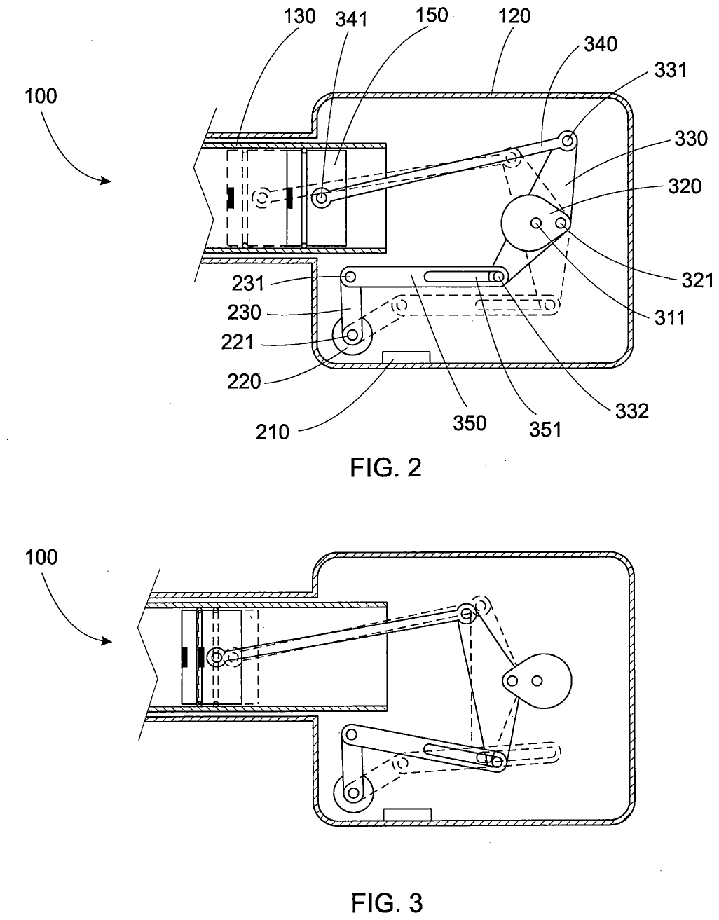

Taking the above description into consideration, in order to suppress the fluctuation of the impact energy, the massage apparatus 100 controls the distance between the driving element 150 and the massaging element 140 by changing the center position of a stroke of reciprocal movement of the driving element 150 based on hardness of a user's body. Thus, as shown in FIG. 2 and FIG. 3, the other end of the control member 350 is swingably supported with respect to the main housing 120. That is, the control member 350 is attached to a switching pin 231 of a switching member 230. The switching member 230 is rotatably attached to the a driving shaft 221 of a driving member 220. The driving member 220 is affixed to the main housing 120. Accordingly, when the switching member 230 is rotated, the switching pin 231 acts as a swinging fulcrum of the control member 350 which is rotated around a center axis of the switching pin 231. Solid lines in FIG. 2 and FIG. 3 illustrate a state in which the swing member (330) is moved and positioned forward by rotation of the switching member 230. Further, dashed lines in FIG. 2 and FIG. 3 illustrate a state in which the swing member 330 is moved and positioned rearward by rotation of the switching member 230.

As shown in FIG. 2, and FIG. 3, when the position of the switching pin 231 of the switching member 230 is changed, the swing member 330 is moved forward or rearward via the control member 350 with the eccentric pin 321 as the fulcrum. Thus, the driving element 150 is moved forward or rearward via the connection rod 340. As a result, stroke center position of the driving element 150 is moved front-rear direction (moving direction of the driving element 150). That is, when the control pin 332 is moved forward, the stroke center position of the driving element 150 is moved rearward, and when the control pin 332 is moved rearward, the stroke center position of the driving element 150 is moved forward. Accordingly, the swing member 330 having the eccentric pin 321 as the swinging fulcrum of the swing member 330 is served as a stroke center position changing mechanism which changes the stroke center position of the driving element 150. Further, continuous lines and broken lines in each FIG. 2 and FIG. 3 illustrate the switching member 230 are rotated in approximately 90 degrees to each other.

As shown in FIG. 2 and FIG. 3, a driving member 220 is provided for rotationally operating the switching member 230. The switching member 230 is rotatably connected to the driving member 220 via a driving shaft 221.

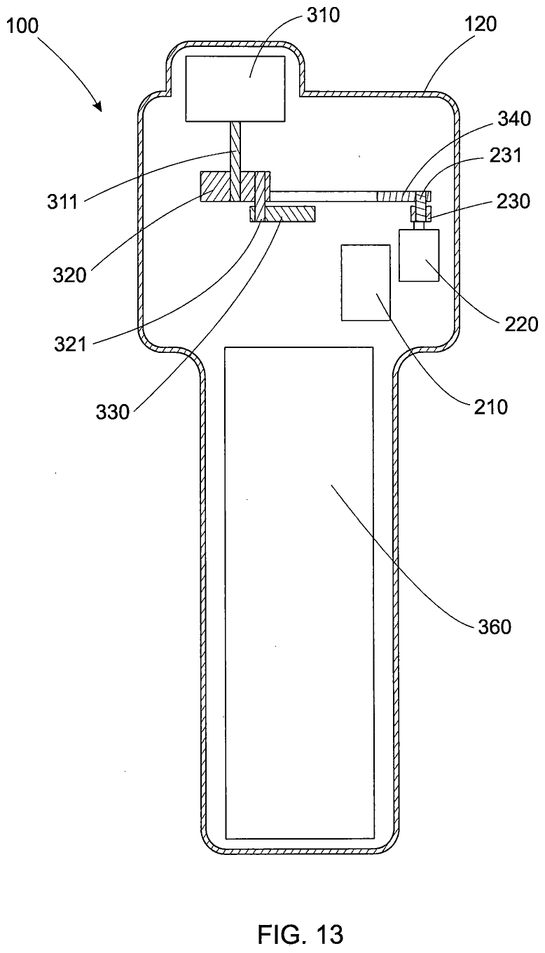

The driving member 220 is controlled by the control panel 210 illustrated in FIG. 2 and FIG. 13. The control panel 210 controls the driving member 220 based on the hardness of a user's body. For this purpose, measuring means for measuring a parameter which indicates the hardness of a user's body is provided in the massage apparatus 100. The control panel 210 evaluates the hardness of a user's body based on a result of measurement which is inputted from the measuring means. If the hardness of a user's body is hard, the control panel 210 controls the driving member 220 such that it moves the stroke center position of the driving element 150 rearward. On the other hand, if the hardness of a user's body is soft, the control panel 210 controls the driving member 220 such that it moves the stroke center of driving element 150 forward.

As shown in FIG. 1, a massaging reaction force sensor 410 which measures the massaging reaction force acting on the massaging element 140 through the massage head 110, a position sensor 420 which measures a position of the massage head 110, a vibration sensor 430 which measures vibration caused on the main housing 120, and a current sensor 440 which measures current value of the electric motor 310.

The massaging reaction force sensor 410 is an example of a feature which corresponds to “a first sensor (410)” of the present invention, and the position sensor 420 is an example of a feature which corresponds to “a second sensor (420)” of the present invention, the vibration sensor 430 is an example of a feature which corresponds to “a third sensor (430)” of the present invention, and the current sensor 440 is an example of a feature which corresponds to a “fourth sensor (440)” of the present invention.

One of the sensors described above may be utilized independently. On the other hand, some of the sensors may be utilized together. Further, the control panel 210 is controlled such that it adjusts rotational angle of the driving shaft 221 of the driving member 220 in a continuously variable manner. That is, the stroke center position of the driving element 150 is adjusted not only in two positions of its front position and rear position but also in any positions between the front point and the rear position. On the other hand, the stroke center position of the driving element 150 may be switched in a multistage manner.

If the control panel 210 detects based on the result of the sensor that the hardness of a user's body is hard, the control panel 210 drives the driving member 220 such that the switching pin 231 of the switching member 230 is moved forward. Thus, the swinging fulcrum of the control member 350 is moved forward. Accordingly, the swing member 330 is rotated in a clockwise direction in FIG. 2 and FIG. 3 around the eccentric pin 321, and the driving element 150 is moved rearward via the connection rod 340. That is, the stroke center position of the driving element 150 is moved rearward. As a result, the distance between the driving element 150 and the massaging element 140 is increased.

On the other hand, if the control panel 210 detects based on the result from the sensor that the hardness of a user's body is soft, the control panel 210 drives the driving member 220 such that the switching pin 231 of the switching member 230 is moved rearward. Thus, the swinging fulcrum of the control member 350 is moved rearward. Accordingly, the swing member 330 is rotated in a counter-clockwise direction around the eccentric pin 321, and the driving element 150 is moved forward via the connection rod 340. That is, the stroke center position of the driving element 150 is moved forward. As a result, the distance between the driving element 150 and the massaging element 140 is decreased.

As described above, according to the first embodiment, the stroke center position of the driving element 150 is moved based on the hardness of a user's body, and thereby the distance between the driving element 150 and the massaging element 140 is adjusted according to the user's body. Accordingly, variation in impact energy transmitted to the massage head 110 is suppressed. That is, the characteristic of the air spring of the air chamber 160 is controlled accordingly to the hardness of a user's body, and the massage apparatus 100 is driven under an appropriate massaging performable status.

Further, in a state that the massaging reaction force is not occurred before the massaging operation, the driving element 150 is controlled such that the stroke center position of the driving element 150 is located at a forward position within a movable area. Accordingly, lack of rearward movement of the massaging element 140 by the air chamber 160 is prevented.

Further, according to the first embodiment, the control panel 210 changes the stroke center position of the driving element 150 according to the hardness of a user's body. That is, the control panel 210 automatically changes the position of the driving element 150 based on the hardness of a user's body.

Further, according to the first embodiment, the driving element 150 is driven by the link type crank mechanism. Accordingly, as the stroke center position of the driving element 150 is changed, a stroke length of the driving element 150 is changed.

Further, in the first embodiment, the stroke center position of the driving element 150 is changed automatically, however, it is not limited to this. For example, as shown in FIG. 13, the stroke center position of the driving element 150 may be changed by a user.

The correspondence relationships between the constituent elements of the present embodiments and the constituent elements of the present invention are as follows. Furthermore, the present embodiments describe one example of a mode for carrying out the present invention, but the present invention is not limited to the configuration of the present embodiments.

What is claimed is:

1. A massage apparatus which at least linearly drives a massage head at least linearly in a longitudinal direction of the massage head and performs a massaging operation on a user's body, comprising:
a main housing,
a cylinder which is arranged in the main housing and extended in the longitudinal direction of the massage head,
a massaging element which drives linearly in the longitudinal direction of the massage head in the cylinder and interchangeably connects the massage head,
a driving element which is slidably arranged in the cylinder and is configured to move the massaging element,
an air chamber located inside the cylinder between the driving element and the massaging element, and
a driving apparatus which drives the driving element,
wherein the driving element is arranged inside the cylinder such that it reciprocally moves in the cylinder along the longitudinal axis of the cylinder between a first position at which the driving element is most remote from the massage head and a second position at which the driving element is closest to the massage head,
when the driving element is moved from the first position to the second position, the driving element moves the massaging element toward the massage head and the massaging element interchangeably connects the massage head, and
wherein the reciprocal movement of the driving element has a stroke center position relative to the cylinder between the first position and the second position; and
wherein the driving element and driving apparatus are configured to change the stroke center position.

2. The massage apparatus according to claim 1, comprising a switch apparatus for changing the stroke center position.

3. The massage apparatus according to claim 2, comprising a control panel which controls the switch apparatus, wherein the control panel is configured to change the stroke center position by controlling the switch apparatus.

4. The massage apparatus according to claim 3, wherein the switch apparatus comprises a driving member which is controlled by the control panel and a switching member which is switched its position due to a driving of the driving member, and the stroke center position is changed by switching the position of the switching member.

5. The massage apparatus according to claim 3, wherein the control panel is configured to be operable by a user to control the switch apparatus and change the stroke center position.

6. The massage apparatus according to claim 3, comprising a first sensor which measures reaction force caused by the massaging operation of the massage head, wherein the control panel is configured to control the switch apparatus based on a measured result of the first sensor and change the stroke center position.

7. The massage apparatus according to claim 3, comprising a second sensor which measures position of the massage head, wherein the control panel is configured to control the switch apparatus based on a measured result of the second sensor and change the stroke center position.

8. The massage apparatus according to claim 3, comprising a third sensor which measures vibration caused on the main housing, wherein the control panel is configured to control the switch apparatus based on a measured result of the third sensor and change the stroke center position.

9. The massage apparatus according to claim 3, comprising a fourth sensor which measures the current to the motor, wherein the control panel is configured to control switch apparatus based on a measured result of the fourth sensor and change the stroke center position.

10. The massage apparatus according to claim 1, wherein the driving apparatus comprises a motor and a crank mechanism which is driven by the motor, the crank mechanism comprises an eccentric flywheel having an eccentric pin, the eccentric flywheel rotationally driven by the motor, a swing member which is connected to the eccentric pin swingably around the eccentric pin, the massage apparatus further comprises a connection rod which connects the swing member and the driving element, one end side of the connection rod is swingably connected to the swing member and the other end side is swingably connected to the driving element, and a control member one end side of which having a control slot is swingably connected to the swing member and the other end side of which is swingably connected to a switching member arranged on the main housing, and the stroke center position is changed by changing a position of the switching member.

11. The massage apparatus according to claim 10, wherein a stroke length of a driving element is changed when the stroke center position is changed.

12. A massage apparatus in which a massage head drives at least linearly in a longitudinal direction of the massage head and performs a massaging operation on a user's body, comprising:
a main housing,
a cylinder which (1) is arranged inside the main housing and (2) has a center axis,
a massaging element which is slidably arranged within the cylinder,
a driving element which is slid inside the cylinder and drives the massaging element,
a connection rod which is connected to the driving element,
a crank mechanism which is connected to the connection rod and drives a driving element as the driving element,
wherein:
the driving element has a bottom dead center position in which the driving element is most remote from the massage head and a top dead center position in which the driving element is closest to the massage head,
the connection rod has a longitudinal axis, and
the cylinder, the driving element and the connection rod are configured such that, at some point when the driving element is between the top dead center position and the bottom dead center position, but not at the top dead center position or the bottom dead center position.
